(19) United States
(12) Patent Application Publication
(10) Pub. No.: US 2008/0075251 A1
(43) Pub. Date: Mar. 27, 2008

(54) Method of and System for Managing Outgoing Telephone Calls

(75) Inventors: Todd Jefferson, Manotick (CA); Yanick Dufresne, Ottawa (CA); Andrew Hackston, Ottawa (CA); Noam David Tomczak, Ottawa (CA); Alec Saunders, Manotick (CA); Howard H. Thaw, Green Valley (CA)

Correspondence Address: BUCKINGHAM, DOOLITTLE & BURROUGHS, LLP, 3800 EMBASSY PARKWAY, SUITE 300, AKRON, OH, 44333-8332, US

(73) Assignee: Iotum Corporation, a Delaware corporation, Ottawa (CA)

(21) Appl. No.: 11/531,072

(22) Filed: Sep. 12, 2006

(51) Int. Cl. H04M 15/06

(52) U.S. Cl. 379/142.07

(57) ABSTRACT

The present invention relates generally to the field of telecommunications and more particularly to a method of and system for organizing, prioritizing and placing a user's outgoing telephone calls. One embodiment of the invention allows a user to generate an electronic list of telephone calls to be made, the ordering of entries being made by priority level, higher priority entries being placed higher on the list than lower priority entries. The user simply requests that the next highest priority call in the list be made, and the method and system identifies the telephone number for the next party on the sorted list and places the call. Thus, the user can step through his list of calls without having to locate telephone numbers or waste time dealing with unimportant calls. Other embodiments allow the user to determine whether a potential callee is available, or willing to accept his call.

### FIELD OF INVENTION

The present invention relates generally to the field of telecommunications and more particularly to a method of and system for organizing, prioritizing and placing a user's outgoing telephone calls.

### BACKGROUND OF THE INVENTION

In today's business world any tool that can improve employee productivity and efficiency is of great value. Cellular telephones, for example, allow users to receive and place telephone calls while walking to and from various appointments, driving their cars or simply being in any location that is remote from their usual hard-wired telephone in their office or home. Similar mobile functionality is now common on personal digital assistants, Blackberry™ type devices, and in automobile telemetry systems.

However, regardless of whether the user is mobile or stationary, telephony devices do not offer much assistance in organizing, managing and placing outgoing calls. The usual procedure is that the user first remember to call a certain individual, then look up the calling telephone number in a telephone book, on an old business card or scrap of note paper, and then finally to dial the number into their telephony device. This is not a complicated procedure, but it is difficult for the user to remember to place calls to a long list of people, or to call these people again if the first attempt is unsuccessful. Other problems with this procedure include the following:

1) it is inconvenient to search for telephone numbers even while at a desk or at home, more difficult to do while trying to walk in public, and simply impossible or dangerous to do so while driving a car;
2) even when the telephone number is known or easily found, it is still awkward and dangerous to dial all of the digits required to place a call while walking in public or driving a car;
3) the user has no idea whether the party he is calling will be available, or whether he is interested in receiving the call. Interrupting an individual at an inconvenient or inappropriate time, could damage an important relationship; and
4) if the user has a multitude of calls that he must make, he has no idea which calls should be made first. The user could easily spend time placing or attempting to place insignificant calls, not realizing that his important client is only available for the next hour, and that he will miss him by the time he places the call.

While the user is busy placing calls or performing other activities, his voicemail and email system will be accumulating messages that the user will not be aware of until he decides to check these systems. Again, important messages may be left on the voicemail or email system, while the user is wasting time with less important calls or other matters. This can result in missed opportunities to deal with important clients and issues.

There is therefore a need for a method of and system for organizing, prioritizing and placing outgoing telephone calls which is more convenient, safer and which otherwise addresses the problems outlined above. This system and method should be user-friendly, compatible with existing communication infrastructure and cost effective.

### SUMMARY OF THE INVENTION

It is an object of the invention to provide an improved method of and system for organizing, prioritizing and placing outgoing telephone calls to be made by a user, which obviates or mitigates at least one of the disadvantages described above.

The system of the invention allows the generation and maintenance of an electronic list of telephone calls that are to be made by a given user. It is like a to-do list, except that the actions are calls to specific individuals. The calling list may be populated from the user's address book and/or directory, as well as automatically from voicemail messages or email messages that are received. The calling list is designed to help users better prioritize calls which they wish to make in any given day, the telephone calls being sorted and listed by priority. The ordering of the calls in the list may change with respect to the availability of the parties and changing events. All the user must do to place a call is click on the “next” icon, and the system will locate the next highest priority call on the list and dial the telephone number associated with it.

An entry on the To-Call list, once created, is a reminder to call a specific individual when that person is available to take the call. The To-Call list is preferably sorted by the callee's willingness to enter into the call, alphabet, and date. Entries may be created flagged as “Call Today”, “Call Tomorrow”, “Call Next Week”, and custom—call at a specific time and date. If multiple address book or directory entries are selected, and added to the To-Call list, they may also be flagged as “Conference Today”, “Conference Tomorrow”, and so on. To create an entry the member may perform any of the following actions:

1. drag a contact from the directory, or address book, onto the To-Call list;
2. right click a contact, and choose “Call Today”, or some other appropriate flag; or
3. drag a contact and drop it on a specific calendar entry.

Once added to the To-Call list, callee's entries include a display of name, and willingness to communicate at the instance in time when the list is rendered. If the system determines that an individual's availability or willingness to communicate has changed, then the system will update the display accordingly, and resort the list. If the callee does not have software that supports the willingness notification, then IM presence (Instant Messaging presence), if available, will serve as a substitute. If IM is not available, then an email may be used to inform the callee that a particular individual would like to reach them, to display times when the member is willing to communicate, and to schedule a call.

In cases where there is a scheduled call, the system may present a reminder to the user at the time the call is scheduled.

For example, a busy executive may have an hour long commute in his car each day, traveling to and from his office. During his travel, he may wish to make some phone calls to improve his productivity. From his Blackberry™, he may select a list of people he would like to reach, and add them to his “To-Call” list. Once in the car, he uses the system to automatically determine the willingness of each of the people on his calling list, and then initiates a call to them. At no time does he have to take his eyes off the road to look up telephone numbers, or to dial telephone numbers. He does not reach the voicemail for the callees because the system has checked on the availability of the callees prior to placing the call. Thus, the executive only has to make one click for each call, and the system takes care of the details.

A little while later, the executive is approached by a salesman attempting to sell a product. The executive appreciates that he should obtain input from a number of colleagues and drags their contact information from his address book, into a new entry on the to-call list. The system automatically determines when all of the parties will be available and when that time arrives, the executive will be prompted that his conference call can be initiated. With a simple click, the user's conference call will be set up and all of the parties contacted.

One aspect of the invention is broadly defined as a method of telephone call management comprising the steps of: generating an electronic list of telephone calls to be made, each entry in the list including a textual identifier and a telephone number; sorting the ordering of entries in the list of telephone calls to be made, by priority level, higher priority entries being placed higher on the list than lower priority entries; displaying the sorted list; and responding to a request by a user, to place a telephone call, by: identifying the telephone number for the first party on the sorted list; and dialing the telephone number corresponding to the identified telephone number.

Another aspect of the invention is broadly defined as a method of operation for a telephony device comprising the steps of: generating an electronic list of telephone calls to be made, each entry in the list including a textual identifier and a telephone number; sorting the ordering of entries in the list of telephone calls to be made, by priority level, higher priority entries being placed higher on the list than lower priority entries; displaying the sorted list on the telephony device; and responding to a request by a user, to place a telephone call by: identifying the telephone number for the first party on the sorted list; placing the telephony device off-hook; and dialing the telephone number corresponding to the identified telephone number on the telephony device.

A further aspect of the invention is broadly defined as a telephony device comprising: a memory for storing data and executable software code; a processor for executing the stored software code; a display operably connected to the processor; a network interface for connecting the telephony device with one or more communication networks; an audio input and output for communicating with a user; the memory storing executable software code, operable to execute on the processor and perform the steps of: generating an electronic list of telephone calls to be made, each entry in the list including a textual identifier and a telephone number; sorting the ordering of entries in the list of telephone calls to be made, by priority level, higher priority entries being placed higher on the list than lower priority entries; displaying the sorted list on the display; and responding to a request by a user, to place a telephone call by: identifying the telephone number for the first party on the sorted list; and dialing the telephone number corresponding to the identified telephone number.

This summary of the invention does not necessarily describe all features of the invention. The above mentioned and other objects of the present invention will become more readily apparent from a reading of the following detailed description taken in conjunction with the accompanying drawings wherein like reference numerals indicate similar parts, and with further reference to the appended claims.

### BRIEF DESCRIPTION OF THE DRAWINGS

The invention may take form in certain parts and arrangements of parts, numerous embodiments of which will be described in detail in the specification and illustrated in the accompanying drawings which form a part hereof. These and other features of the invention will become more apparent from the following description in which reference is made to the appended drawings wherein:

FIG. 1 presents a state diagram of a method of manually editing a call list in an embodiment of the invention;

FIG. 2 presents a state diagram of a method of adding a voicemail call to a call list in an embodiment of the invention;

FIGS. 3a and 3b present state diagrams of a method of adding a “call me” email to a call list in an embodiment of the invention;

FIG. 4 presents a state diagram of a method of updating a call list in response to changes in a callee's context or status, in an embodiment of the invention;

FIG. 5 presents a state diagram of an alternate method of updating a call list in an embodiment of the invention;

FIG. 6 presents a state diagram of a method of adding a conference call from an email in an embodiment of the invention;

FIG. 7 presents a state diagram of a method of broadcasting to targets in an embodiment of the invention;

FIG. 8 presents a state diagram of a method of placing calls from a call list in an embodiment of the invention;

FIG. 9 presents a block diagram of a calling list system in an embodiment of the invention; and

FIG. 10 presents an electrical block diagram of an exemplary mobile device in an embodiment of the invention.

### DETAILED DESCRIPTION

An exemplary system and method that satisfies the requirements outlined above will be illustrated by way of the following examples.

The core of the invention lies in client software that may operate on any user telephony device with the necessary resources and functionality. This would include, for example, a mobile device such as a wireless personal digital assistant (PDA), cellular telephone, satellite telephone, Internet-ready cellular telephone, Blackberry™, Microsoft™ Smartphone™, Symbian™, Treo™, or similar device. It may also be a stationary device such as a standard desk-top telephone, PBX-based telephone, telephony-enabled personal computer, voice over IP (VOIP) desktop telephone, or any similar device. These devices all have the resources to either store and execute the client software, or access it as a Web client. As well, most of these devices will be able to supply context data to the system, and allow access to the profile, directory, and address book.

As noted above, the client software maintains a list of parties that the user is to call, along with their telephone numbers. This list may be populated manually by the user, for example, by double-clicking on entries in an address book, or automatically, from emails or voicemails.

The client software is described in the context of multiple state diagrams, implying that the invention should be implemented using a multi-processing operating system. While this might be preferable in some applications, it is certainly not essential as any operating system may be used, regardless of whether it is multi-processing or uni-processing.

As well, it might be assumed that a real-time operating system is preferred, but the resource requirements of the system are so modest that most non-real-time telephony devices are sufficiently fast.

Referring now to the drawings wherein the showings are for purposes of illustrating numerous embodiments of the invention only and not for purposes of limiting the same, the figures illustrate the system of this invention.

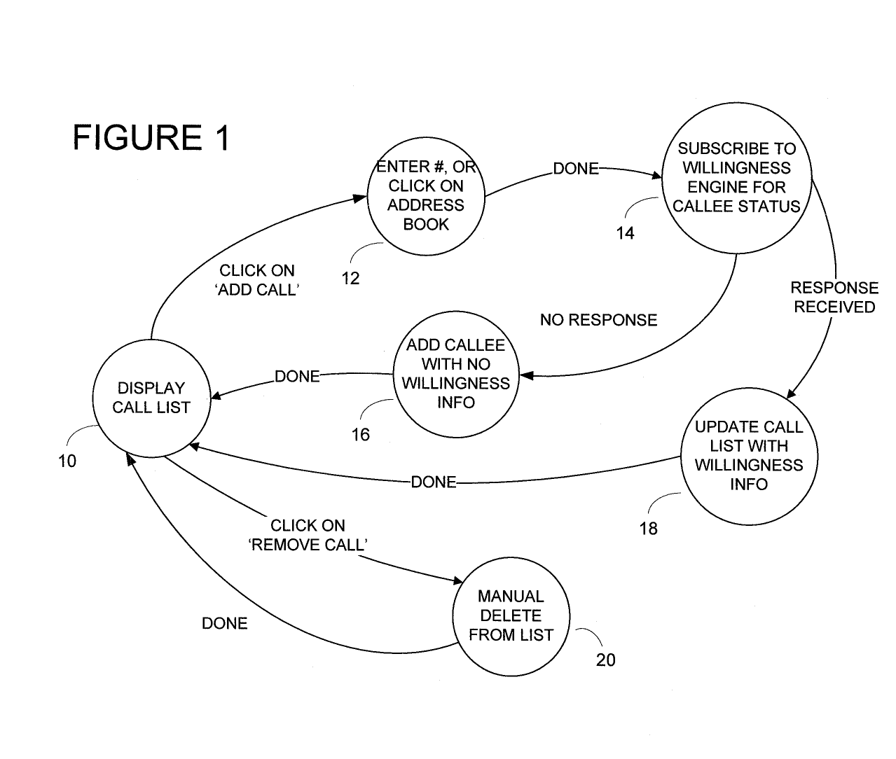

FIG. 1 presents a state diagram of a method of manually editing such a call list, by adding or removing call entries. The default state for the client software is to display the call list 10 on whatever device the user is employing. The call list may be physically resident on the device, or be remote, supported for example, by an ASP (application services provider) system. In such an environment the user could access his list with any Web browser-enabled device, from any location that has access to the ASP.

When the user clicks on an “add call” tab or menu option, he can then add a new telephone number and textual identifier (i.e. the name of the party to call, or “callee”) to the call list 12 by:

1) manually typing in the information;
2) clicking on an entry in his address book such as a Microsoft Outlook™ or Groupwise™ address book;
3) dragging and dropping the data from an email message, Web page or other source;
4) cutting and pasting this information into the call list;
5) dragging a contact from the directory, or address book, onto the call list;
6) right clicking on a contact, and choosing “Call Today”, or some other appropriate flag; or
7) dragging a contact and dropping it on a specific calendar entry.

### As noted herein below, other online address books could be used, or even an address book that is custom to the software of the invention.

As part of the process of entering a new call, a new entry may be flagged as “Call Today”, “Call Tomorrow”, “Call Next Week”, or “custom”, that is, to call at a specific time and date. If multiple address book or directory entries are selected, and added to the To-Call list, they may also be flagged as “Conference Today”, “Conference Tomorrow”, and so on.

Once this has been done, the client software will then subscribe to the willingness engine for the new callee 14 to determine the status for the new callee which has just been identified. A description of a “willingness engine” or “relevance engine” appears in the co-pending U.S. patent application Ser. No. 11/382,130 titled “Method of and System for Presence Management in Telecommunications”, and is incorporated herein by reference. In the case of step 14, the relevance engine's task is simply to advise when the callee will be available to accept a call.

In the general case, the relevance engine considers how to handle communications based on the user's current “context”, and a set of rules that the user has established. The relevance engine may be set up, for example, to determine the current physical location of a particular participant by monitoring usage of their desk top computer, cellular telephone or home telephone, and making an attempt to locate the participant at a corresponding telephony device. If the callee is using his desktop computer to send emails, for example, the relevance engine will expect that the participant can be reached at his desk top telephone. The relevance engine may also have specific rules established which prevent unimportant telephone calls from going to the callee immediately prior to a conference call (for example), or conversely, send unimportant calls to voicemail while the user is in a meeting with his boss.

Some of the context parameters that the relevance engine might consider include the following:

current day and time,

On/Off hook status of the user's various communication devices,

the user's current activity, determined perhaps, by the user's scheduling software,

whether there is current activity on the user's personal computer,

the user's communication history with the other party,

Physical Velocity of the user (driving, running, etc.),

Mood of the user,

Ambient noise and environment, and

Location of the user.

If the client software issues a request for willingness status to a callee and no response is received, then the callee is simply added to the calling list without any willingness information 16. Processing then returns to the home state of displaying a call list 10.

If the callee does not have software that supports willingness notification, then IM presence (Instant Messaging presence), could serve as a substitute. Of course, IM presence will only indicate availability, in contrast to actual interest in entering into the call. That is, if an IM presence server (IM presence servers being common in IM systems) indicates that the callee is online, then it can be assumed that the callee is at his personal computer and is able to accept calls at that location. If IM presence is not available, then an email may be automatically sent to the callee indicating that a particular individual would like to reach them, displaying times when the caller is willing to communicate, and inviting them to identify a time at which to call.

If the callee does have a willingness engine associated with him, then a willingness response will be received and the call list will be updated with the willingness information at 18. The system then returns to the home state of displaying the call list 10.

By determining whether the callee is physically available to his telephony device, and/or is willing to accept the call, the user has a much higher chance of placing a call successfully. Thus, the user can avoid leaving messages on voicemails.

Also from the home state of displaying the call list 10, the user may click on a “remove call” tab or menu selection, which will manually delete the identified call entry from the calling list at state 20. The system then returns to the home state of displaying the call list 10.

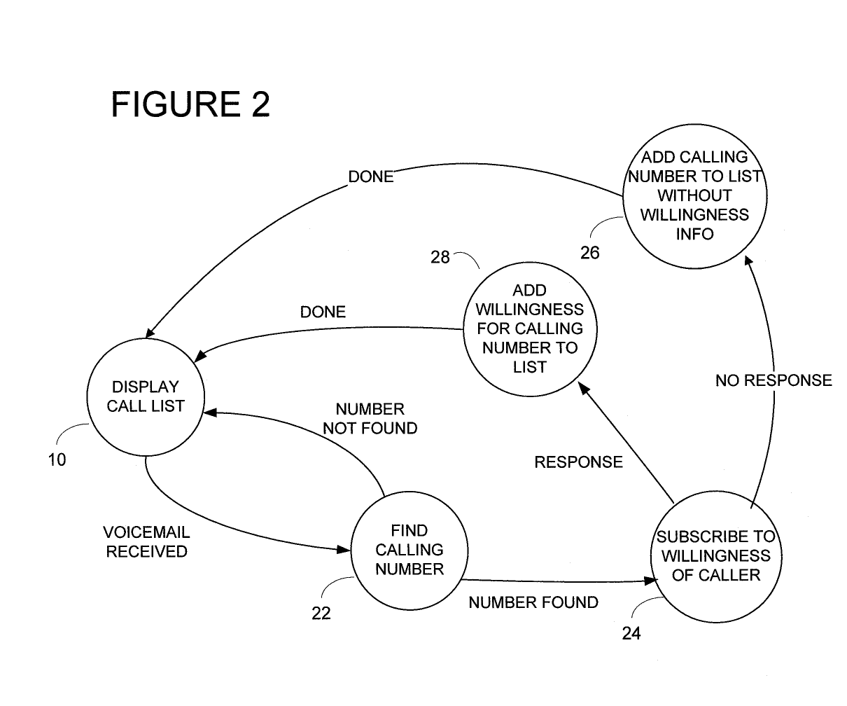

FIG. 2 presents a state diagram of a method of adding a voicemail call to a call list.

As noted above, the home state for the client software is the displaying of the call list at state 10. If the user receives a voicemail at any time, then processing transfers to state 22 where the client software will endeavor to find the calling number associated with the voicemail that has just been received. If the calling number is not found, then processing returns to the home state of displaying the call list and the call list is not affected at all.

If the calling number is found at state 22, then processing moves to state 24 where the client software will subscribe to the willingness engine of the calling party in the same manner as in FIG. 1. If the calling party does not have a willingness engine associated with him or it simply cannot be reached, then processing moves to state 26 where the calling number is added to the calling list without adding any willingness information. Processing returns to the home state of displaying the call list 10.

If the calling party does have a willingness engine associated with him and a response is received, then his willingness information will be added to the calling list at state 28, after which processing returns to the home state of displaying the call list.

In either case of adding the new call entry to the calling list, a flag could be included indicating that the listing was generated pursuant to the receipt of a voicemail message. This would give the user the opportunity to check his voicemail to listen to the complete voice message in advance of returning the call. As well, callers who are leaving voicemails could be prompted to identify the level of urgency of the call, information which could easily be imported into the call list system and used to prioritize the call entry.

It is desirable that the voicemail system be custom designed to optimize compatibility and interoperability with the call management system of the invention, but this is not essential. Many exiting voicemail servers provide an IMAP interface which allows communication with other software systems. Thus, voicemail messages can be advanced easily to the user without having to exit the system.

As well, call entries originating from voicemails can be flagged as deleted on the voicemail system, marked as read, or marked as unread. A simple voicemail dashboard allowing users to listen to their voicemail from a web client could also be implemented as a separate software module.

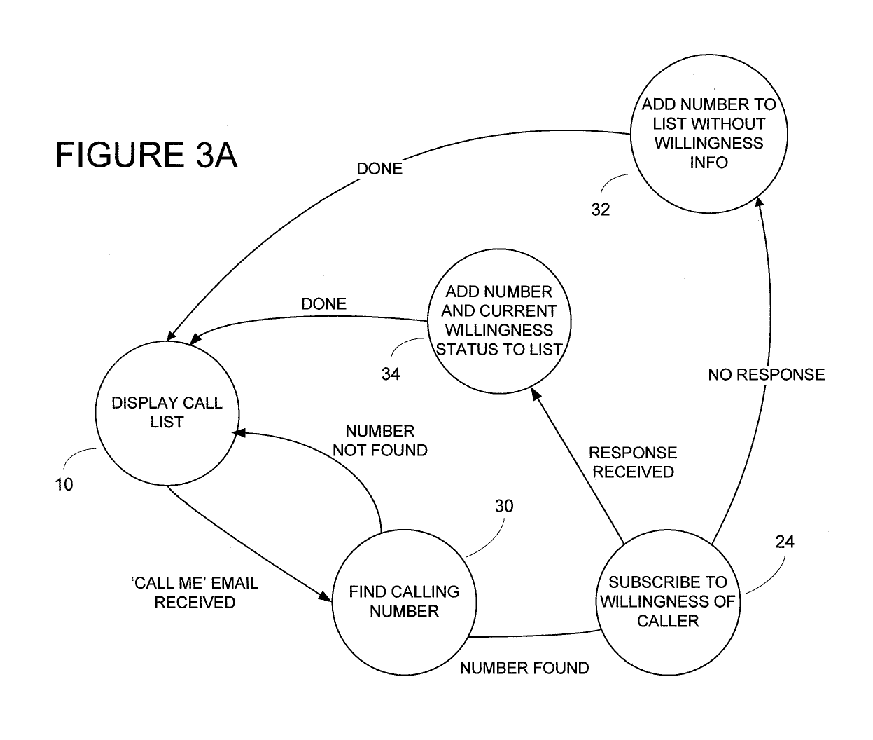

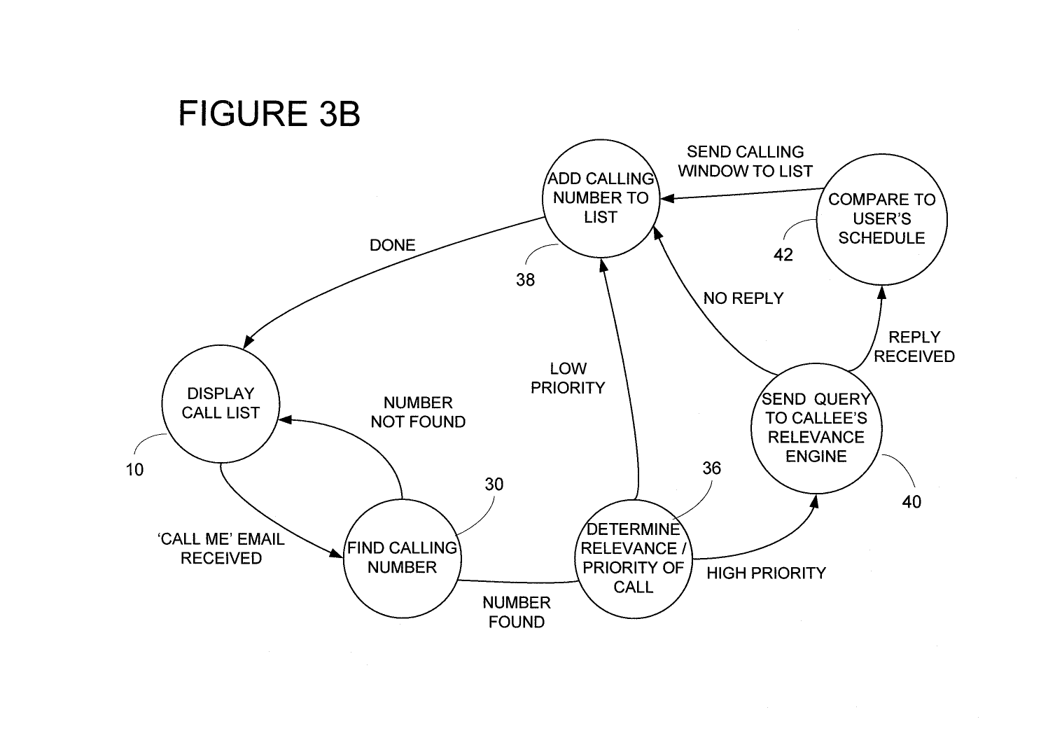

A similar process to the voicemail handling of FIG. 2 is performed if the user receives an email with a “call me” request in it. A “call me” email might arrive with some sort of special attachment, or in a format which is recognized and parsed by the client software. It might be a meeting request (in a standard format attachment such as .ics) which has specific text to which the software recognizes. It also might be require that the user identify it as a “call me” email, and push a user interface element to indicate that a call needs to be made, which would send the new call entry to the call list. FIG. 3a presents a state diagram of a method of adding a “call me” email to the calling list.

From the home state of displaying the call list, the client software may receive an email request asking that the user call a certain party. When such an email is received, the client software will attempt to locate the calling number 30, for example:

1) the email may have a VC card attached, containing the callee's telephone number;
2) the return email address could be used to index the user's address book. If the user already has an entry corresponding to this email address, it may contain a telephone number; or
3) the email itself may contain the telephone number, though a parsing software routine would be required to identify the callee's telephone with any degree of certainty.

If the callee's telephone number is not found, then the “call me” email will simply be disregarded and processing return to the home state. Alternatively, the client software may advise the user that an attempt was made to locate the calling number associated with the email but none was found. Either way, the “call me” email will still remain in the user's email inbasket for disposal.

The way in which the email server sends notifications or communicates in general with the client software depends on the implementation. For example, with Microsoft Outlook, one could use a plugin which sends calendar events and contacts up to the local server supporting the invention. This could be extended to examine incoming emails and send information to the local server supporting the invention as required. However, it could also live on the server as well. For devices such as RIM's Blackberry, one could ran software on the RIM server which examines incoming emails.

If the callee's telephone number is found, then processing transfers to state 24 where the client software subscribes to the willingness engine of the caller. If the caller does not have an accessible willingness engine associated with him or her, then processing passes to state 32 where the calling number is simply added to the calling list without having any willingness information associated with it.

If the calling party does have a willingness engine associated with him or her, that is accessible to the user, and a response is received, then the telephone number of the calling party and their current willingness state is added to the calling list at state 34. The new call entry could include a flag indicating that the listing was generated pursuant to the receipt of an email—this would prompt the user to check his email inbasket to obtain further details. Processing then returns to the home state at state 10.

An alternative method of processing a “call me” email is presented in the state diagram of FIG. 3b. This method considers the priority of the incoming call request. The steps of this method could be integrated with those of FIG. 3a. Similarly, “priority” information could also be integrated with the methods of either of FIG. 1 or 2.

From the home state of displaying the call list 10 in FIG. 3b, the client software will respond to an email with a “call me” request by attempting to find the calling party's number at state 30. If no suitable telephone number is found, then the state returns to the home state. The processing at states 10 and 30 would be performed in the same manner as described above with respect to FIG. 3a.

If a suitable calling number is found, then control transfers to state 36 where the relevance/priority of the call is determined. If the call is determined to be a low priority call, then it is simply added to the list at state 38, after which processing returns to the home state 10.

Calls may be prioritized in different ways, for example, using the relevance engine as described in the co-pending U.S. patent application Ser. No. 11/382,130 titled “Method of and System for Presence Management in Telecommunications”, and incorporated herein by reference. As described in that application, context information as described above, is considered in view of various rules. The rules may include, for example:

for VIPs, I am always available.

during work hours, I am available for co-workers.

during work hours, I am busy for Friends and Family.

outside of work hours, I am available for Family.

my wife, always has full access.

during Work Hours, Co-workers have full access.

outside of work hours, Family has full access.

authorized contacts have limited access.

unauthorized contacts have no access.

### Thus, the system can apply the rules and decide whether the call is important, and how important it is.

If it is determined that the calling party is a high priority call, then a query is sent to the callee's relevance engine at state 40 so that a mutually convenient time or times to communicate, can be identified.

If no reply is received from the callee's relevance engine, then processing continues to state 38 where the call number is simply added to the list and the call list is simply displayed. If a reply is received from the callee's relevance engine, then the reply is compared to the user's schedule 42 so that a time both the user and the calling party are available, can be determined. The calling window, that is, the time or times when both parties are available, will then be identified in the calling list at state 10.

As described above, the call list is sorted with respect to priority and availability of the parties. Thus, the calling window identified in state 42 is very important as it will cause the new call to move up and/or down on the list with regard to the current time and date, and the availability of both parties. For example, if either of the parties is unavailable at the current time and date, then the call will be placed low on the calling list, and will have a flag associated with it indicating that one or other of the parties is not available. Conversely, if both parties are currently available, and there is only a very small time window over the next few days during which the two parties can communicate, then the call will be moved to the top of the list.

If the calling list contains two or more calls of this type, they can be compared to one another, and the call with the smaller time window take priority over calls with larger time windows. The system could also sound a special announcement or special ringtone when a call with a sufficiently small window becomes available, bringing the event to the user's attention. A ringtone that is distinct from the user's ringtone for regular telephone calls could be used.

The above examples of adding calls to the calling list manually, in response to a received voicemail and in response to a received email, are just a few of the many ways the calling list could be populated. For example, functionality could be added to existing voicemail or email systems, providing the option of having a new call added to the calling list. In a voicemail environment, for example, the interactive voice response system usually used to prompt the user to decide whether to save or destroy a received voicemail, could add the option of “entering a reminder in our calling list”.

Similarly, some address books have the options of calling or emailed a party when an address card is viewed. It would be straightforward to add a new “add entry to calling list” menu tab to the existing address book GUI (graphic user interface).

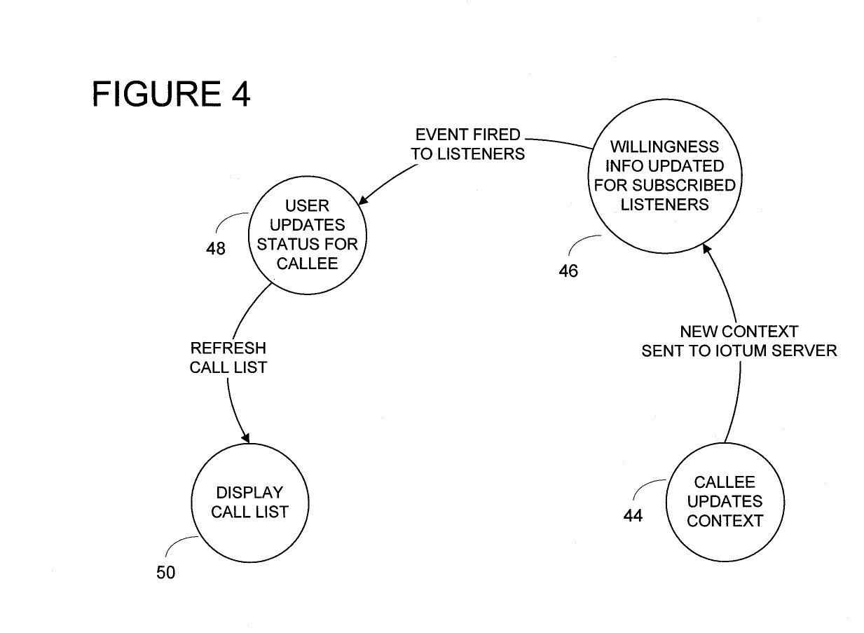

As noted above, the calling list is preferably updated periodically and also in response to certain events, such as changes in the schedule of the user or callees, or changes in context. FIG. 4 presents a state diagram of a method of updating a call list in response to changes in a callee's context or status. This method assumes that either all of the parties are connected to the same presence/willingness server, or their respective presence/willingness servers are configured to communicate with one another.

If a given callee updates his context at state 44, then his client software will send his new context to his associated presence/willingness server. The presence/willingness server will receive this transmission and update its own records, but it will also identify any “subscribed listeners”, that is, parties that have registered a request to receive updates on the context of a given party. A transmission will then be made to each of the listeners, who will update their records at state 46. Each of these listeners will then refresh their calling lists 48 and display them to their respective users at state 50.

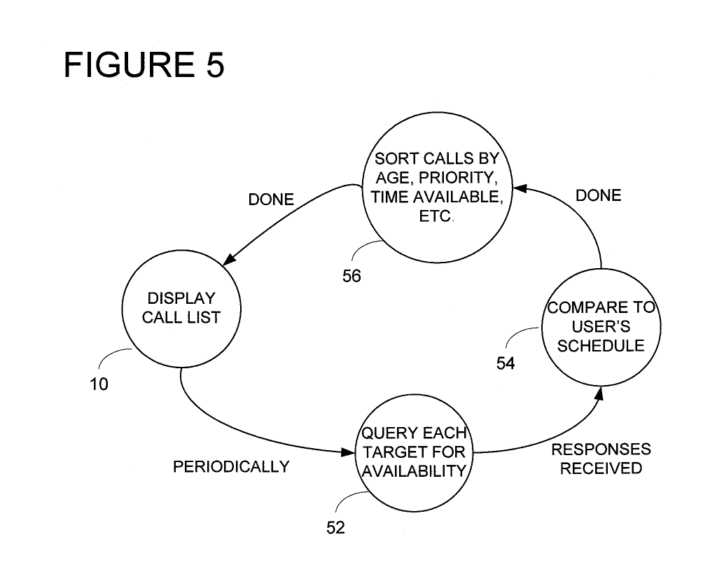

FIG. 5 presents a state diagram of a method of periodically updating a call list. From the home state of displaying the call list 10, the client software may periodically query each target on the calling list for their availability at state 52. Responses received from the targets are then compared to the user's schedule at state 54 so that mutually convenient communication times can be identified. The call entries in the list are sorted at state 56 using parameters determined by the user or system administrator, such as sorting by age (i.e. time since the call request was first entered or identified), priority level or time availability. Other parameters could also be used. The updated call list is then displayed to the user at state 10.

The process of FIG. 5 does not have to be limited to a periodic execution, but can be performed any time there is a change in the context of the user or callees, or simply when a manual request is made by the user. For example, the user may wish to perform an update before going off line, simply to see whether there have been any dramatic changes since he last reviewed the calling list. As noted above, it is possible for new entries to appear unexpectedly (in response to an email request, for example), or to move around dramatically in terms of priority (for example, a callee's meeting has ended early, and he is suddenly available to accept a call).

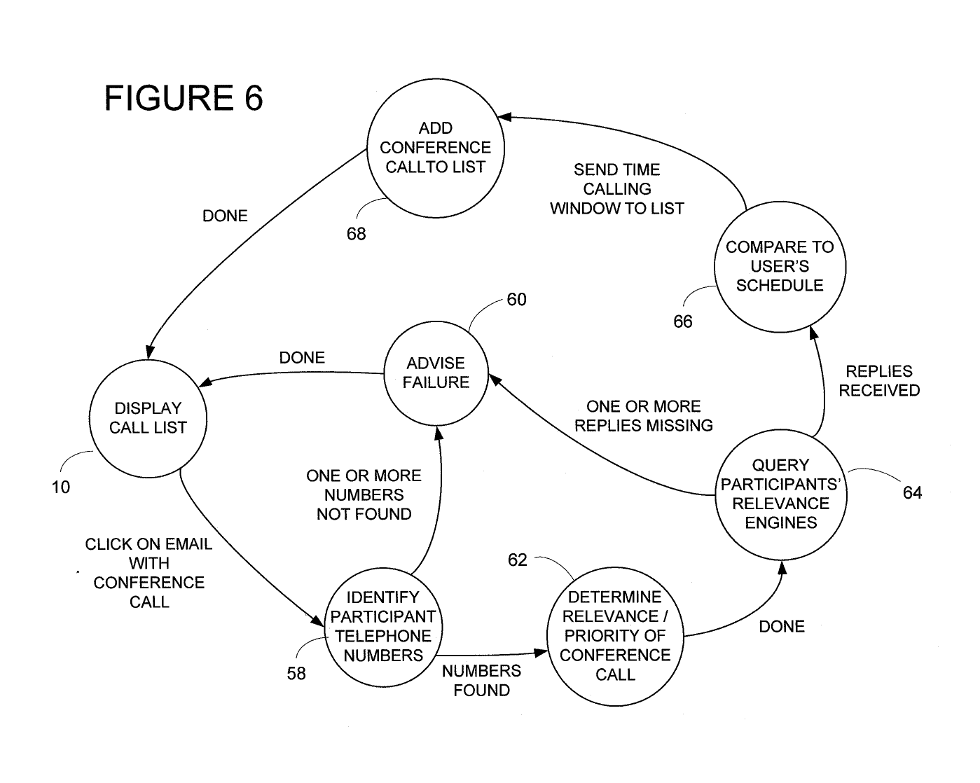

A very convenient application of this system is in arranging calls involving multiple parties (i.e. conference calls). FIG. 6 presents a state diagram of a method of adding a conference call to the calling list, which has been originated by an email. Of course, a similar methodology could be used to set up a conference call manually or in response to a voicemail being received.

When the user generates an email to propose a conference call, the client software will attempt to identify participant telephone numbers at state 58. Similar to the method described above with respect to FIG. 2, this could be done by searching for the callee's VC card, locating a return email address, reviewing the user's address book, or parsing content from an email.

If one or more of these participant telephone numbers is not found, then it will not be possible to arrange a conference call and a failure notice will be raised and sent to the user at state 60. If all of the participant telephone numbers are found, then the relevance/priority of the conference call will be determined at state 62 (which will typically be a manual entry by the user), and queries sent to each participant's relevance engine at state 64.

If one or more replies are not received from the participants, then it will not be possible to determine a predictable time for which to hold the conference call. Thus, a failure is reported to the user at state 60.

If all of the replies are received from the participants, then processing moves to state 66 where the conference call is compared to the user's schedule. A time window is then generated indicating times and dates during which all of the participants are available. The conference call is then added to the user's calling list at state 68 identifying all suitable calling times (that is, times in which all of the participants are available).

Now, as the user's calling list is updated, it will place the conference call at a very low priority during times in which one or more participants are not available (and/or flag it as unavailable), while moving the priority of the conference call up higher on the call list at times when all of the participants are available. If the client software determines that the calling window is very small over the next few days, then it can move the conference call right to the top of the list so that the user will address it first.

The system could also sound a special announcement when all of the participants are available, to bring the event to the user's attention. For example, a ringtone that is distinct from the user's ringtone for regular telephone calls could be used.

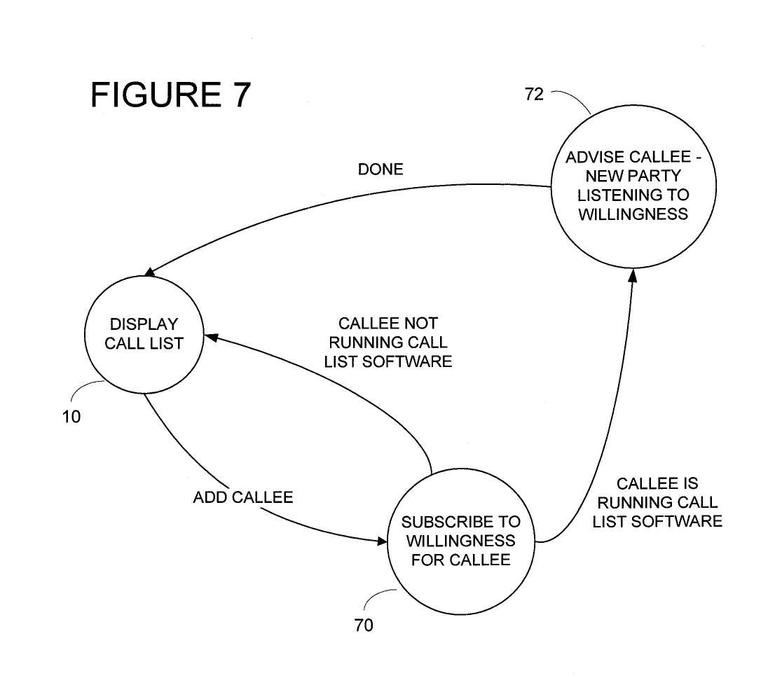

FIG. 7 presents a state diagram of a method of broadcasting willingness to targets on the call list. Provided that callees on the user's call list have the necessary functionality, this process allows the user to advise these callees that the user is interested in contacting them. From the home state, when a callee is added to the list, the client software will attempt to subscribe to the willingness engine for the callee on his associated presence/willingness server 70. If he is unable to do so, then control simply returns to the home state of displaying the call list 10. If the access attempt is successful and the callee is running call list software of his own, then the client software will advise the callee that the new person is listening to his willingness data for the purpose of making the call on the list 72. Once this connection has been made, other complementary information can also be shared between the two parties, such as the most convenient times to communicate, which devices to use, etc. Control then returns to the home state of displaying the call list 10.

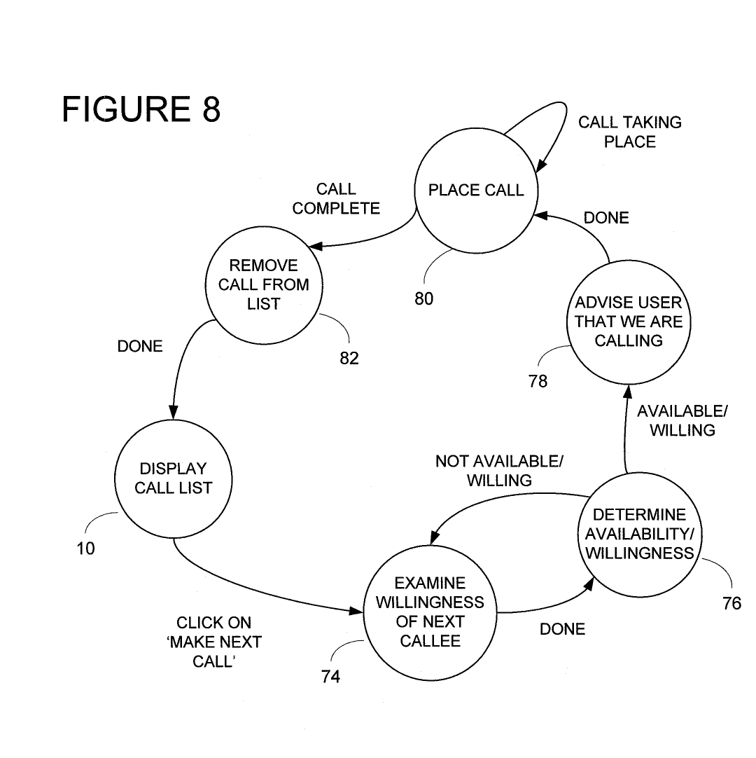

Finally, FIG. 8 presents a state diagram of a method of placing calls from the calling list. Again, the home state of the process is the displaying of the call list to the user 10. From here, the user may click on a “make next call” tab or menu selection. When this is done, control transfers to state 74 of examining the willingness state of the next callee on the calling list and determining whether the callee is available and/or willing to accept the call 76. If the callee is identified as not being available or being unwilling to accept the call at state 76, then processing loops back to state 74 whereby the next callee on the list may be solicited. It is preferable that the user be advised of this situation, that is, that the current callee on the list is not available.

If the next callee on the list is available and is willing to accept the call, then processing transfers to state 78 where the user is advised that the client software will be placing the call. The call is then placed at step 80 and the client software remains in this state until the call has been completed. Once the call has been completed, it is removed from the calling list 82 and processing returns to the home state of displaying the call list 10. The specific details regarding the placing of the call itself will depend on the nature of the telephony system in use. Of course, the invention is independent of the telephony system.

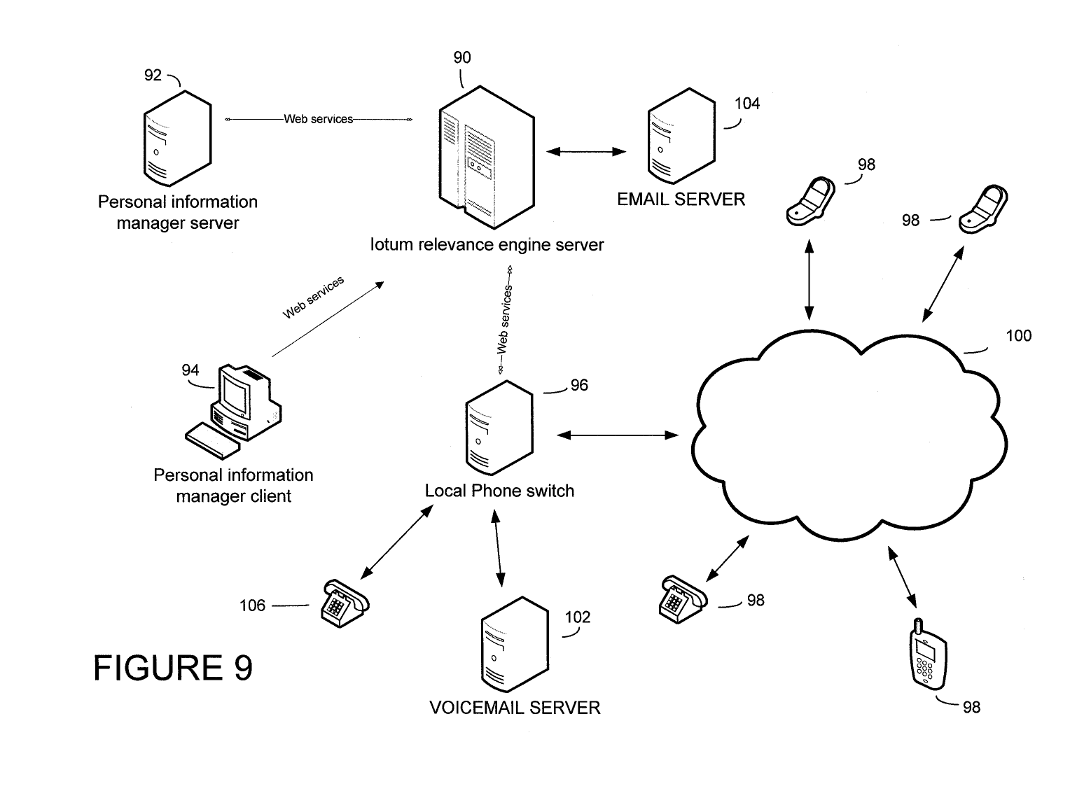

FIG. 9 presents an exemplary block diagram of a suitable system for implementing the invention.

As described above, the functionality of the system is very much centered around the client software. However, to take full advantage of the invention and integrate it with related functionality which provides the full complement of the Iotum technology, the client software is preferably integrated with a relevance engine server 90 and local telephone switch 96. As described above, the relevance engine server 90 is operable to:

examine the user's context stored in a local database;

update the user's context in accordance with scheduling data collected from the user's personal information manager (PIM) server 92;

possibly capture call requests from the local email server 104 and local voicemail 102, forwarding them to the user's client software so that the calls can be entered into the user's calling list (though this functionality could be placed elsewhere, for example, in the local email server 104 and local voicemail 102 themselves);

update the user's presence in accordance with data collected from a local email server 104, the local telephone switch 96 and other devices; and

communicate with other relevance engine servers to share presence, willingness and context information. (It is expected that presence will often come from Instant messaging clients or from their network servers, so communication will typically be required with those presence sources as well.)

The Personal information manager (PIM) server/client 92 can be any compatible, interactive PIM server such as Outlook Exchange/Microsoft Outlook for the PC. The relevance engine server 90 should be able to retrieve contact and calendar information from the PIM server. The Personal information manager (PIM) client 94 is a client plug-in that is integrated with the user's call management system running on their personal computer (PC). It can communicate with the relevance engine server 90 via the network/Internet and pushes up contact and calendar information to the relevance engine server 90. The user's call management software is running on his personal computer, but it supervises the placement of calls on his local telephone 106, via the relevance engine server 90 and local telephone switch 96.

The telephone switch 96 may be any standard device such as a PBX, IP PBX or other system, preferably supporting conference calls and voicemail services 102. The telephone switch 96 should also have the functionality to query the relevance engine server 90 every time an incoming call is received, to receive instructions on how to route the call. Any number of local or remote communication devices 98 may also be a part of the system, including desk top telephones, cellular telephones, personal digital assistants (PDAs), Internet-ready telephones, VOIP (voice over Internet protocol) telephones, television set-top boxes, and the like.

If the user is operating one of the remote devices 98, then the client software on that device will be managing the user's calling list and initiating the related functionality. The client software will communicate with the relevance engine server 90 to update the user's context, the local telephone switch 96 and network 100 simply passing the context data as a dumb communication channel. The client software also interacts with the balance of the components as described herein above. Note that the network 100 may comprise any network capable of supporting telephone-type communications including the Internet, cellular telephone networks, the public switched telephone network (PSTN) and other such wired and wireless networks.

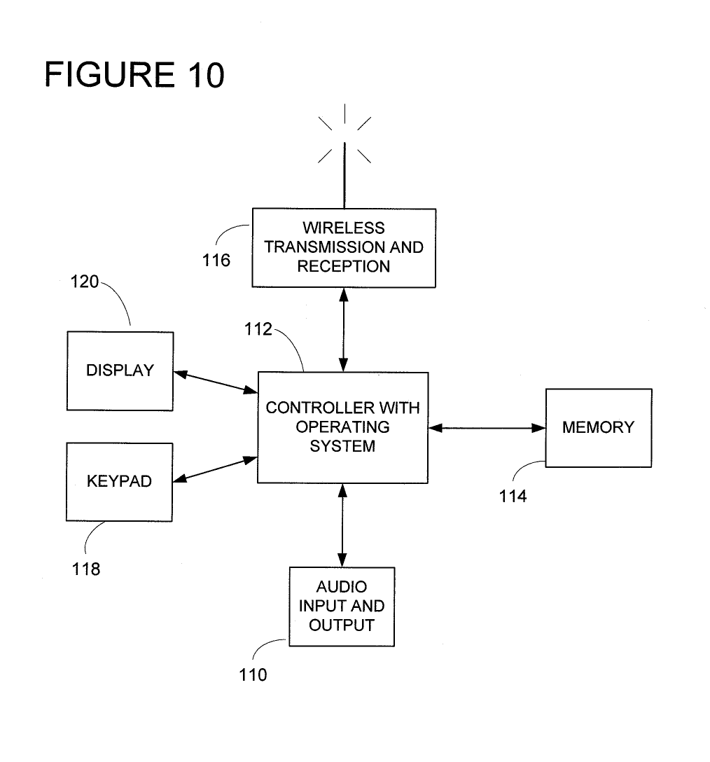

FIG. 10 presents an electrical block diagram of an exemplary mobile device that could be used to implement the invention. Many existing devices have similar functionality and could be used to implement the invention. The invention is not limited to any particular design or architecture.

This device consists of standard electronic components such as the audio input and output 110, which would typically consist of a microphone and speaker, along with analogue to digital and digital to analogue converters to pass voice signals to and from the central controller. The central controller 112 may, for example, be a digital signal processor, microprocessor, microcontroller or ASIC (application specific integrated circuit).

The microprocessor must store the operating system kernel in an internal memory cache or off-processor in an external memory. The client software, similarly, may be stored on- or off-processor. The off-processor memory 112 is preferably a non-volatile memory such as an electrically-erasable programmable read-only memory (EEPROM) or FlashROM, but may also include volatile memory such as a random access memory (RAM). This memory may be used to store any necessary encryption, digitization and protocol algorithms, which may be downloaded via the wireless input/output 116.

The device may include a standard telephone keypad 118 and display 120, but may also include more advanced components. For example, many portable devices now include LCD pixel matrices with high resolution, full-colour graphics. Rather than a traditional twelve-key telephone keypad, the keypad could include a full alpha-numeric keypad, touchscreen, or mouse/pushbutton type functionality.

Other arrangements would also be clear to one skilled in the art from the teachings herein.

The installation of the client software will follow logically from the specifics of the design. In general, the process for setting up the client software or Web-client will consist of the following steps:

1. entering a user name and password, and setting up an account;
2. entering one or more telephone numbers at which the user can be reached;
3. installing any required desktop plug-ins; and
4. running the setup wizard, which will prompt the user to specify preferences regarding:
a. how to handle emails and voicemails; and
b. establishing unique ringtones for various events such as the availability of high priority callees, or the availability of all parties in a conference call.

The general intention is to implement the described method and system as part of the Iotum relevance system as described in the following co-pending United States patent applications, incorporated herein by reference:

1) application Ser. No. 11/382,130 Filed May 8, 2006, titled “Method Of And System For Presence Management In Telecommunications”;
2) application Ser. No. 11/382,142 Filed May 8, 2006, titled “Method Of And System For Telecommunication Management”; and
3) application Ser. No. 11/457,258 Filed Jul. 13, 2006, titled “Method Of And System For Conference Calling”.
As part of that system, the user references and rules will be input and defined as described hereinabove. If the method and system is to be offered without the balance of the Iotum technology system, then it may be necessary to include functionality to collect all of this information directly from the user, rather than obtaining it from the Iotum system.

### ADVANTAGES

The various embodiments of the invention provide many advantages over the prior art. For example, users no longer have to remember long lists of people that they wish to call, nor do they have to make note when they receive a voicemail or email asking that they call someone. Such requests are automatically placed on their calling list.

Users no longer have to hunt around for telephone numbers, an inconvenience at the best of times, and often dangerous or impossible with mobile users. Users simply make a single click to place each successive call, without having to look at the device, read any text or type in any characters.

The calling list automatically places the highest priority calls at the top of the list, updating the list in real time as call requests arrive. Calls from the boss or an important client can be advanced ahead of calls from salespeople or telemarketers, for example, based on a set of rules defined by the user. Also, the user does not have to worry about an important call request becoming stale on his email or voicemail as those requests are automatically added to his calling list and assigned a position in accordance with their priority level.

The system also investigates the availability and willingness of callees to receive calls, minimizing the number of calls that end up at a callee's voicemail. This also minimizes the likelihood of placing a call at a time that is inconvenient or inappropriate for the callee.

Thus, the invention provides major advances in organizing, managing and placing outgoing calls, for both mobile and stationary telephony devices. This method and system is more convenient, safer and user-friendly than existing systems. It is also a cost-effective system that is compatible with existing communication infrastructure.

### OPTIONS AND ALTERNATIVES

While particular embodiments of the present invention have been shown and described, it is clear that changes and modifications may be made to such embodiments without departing from the true scope and spirit of the invention. For example:

1. the system could be integrated with online contact management systems such as Plaxo and LinkedIn;
2. the system could be integrated with online email systems such as Hotmail, allowing access to all of the user's online address books;
3. logs could be kept of all: success calls, attempts made to place each call, the outcome of the attempts, and data regarding the removal of a call from the calling list. The log could record caller ID, time the call was made, duration and other data;
4. users could be given the option of accessing removed call entries, and generating new call entries based on old ones (for example, generating a new entry to call back in x days);
5. many flags and notes could be added adjacent to call entries in the calling list. For example, the willingness of each caller to engage in a conversation with the viewer could be displayed. If the call entry is a missed call and a voicemail message was left, a voicemail indicator could be displayed;
6. many actions could be initiated from the call log include examining the callee's profile or address book details, initiating a call, IM or email to the callee, or playing back an old voicemail; and
7. if a callee is unavailable, the system could make suggestions to the user of other ways of communicating with the callee. For example, the system could suggest telephoning, instant messaging, or sending an email to the callee during a specific time window or on a certain day. This process could initiated when the user makes a new entry on his to-call list, or when he attempts to contact a party on his to-call list.

### CONCLUSIONS

The present invention has been described with regard to one or more embodiments. However, it will be apparent to persons skilled in the art that a number of variations and modifications can be made without departing from the scope of the invention as defined in the claims.

The method steps of the invention may be embodied in sets of executable machine code stored in a variety of formats such as object code or source code. Such code is described generically herein as programming code, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, personal digital assistants, Internet-ready telephones and television set-top boxes (STBs). Again, such implementations would be clear to one skilled in the art, and do not take away from the invention.

All citations are hereby incorporated by reference.

In the foregoing description, certain terms have been used for brevity, clearness, illustration and understanding; but no unnecessary limitations are to be implied therefrom beyond the requirements of the prior art, because such terms are used for descriptive purposes and are intended to be broadly construed. Moreover, this invention has been described in detail with reference to specific embodiments thereof, including the respective best modes for carrying out each embodiment. It shall be understood that these illustrations are by way of example and not by way of limitation.

What is claimed is:

1. A method of telephone call management comprising the steps of:
generating an electronic list of telephone calls to be made, each entry in said list including a textual identifier and a telephone number;
sorting the ordering of entries in said list of telephone calls to be made, by priority level, higher priority entries being placed higher on the list than lower priority entries;
displaying said sorted list; and
responding to a request by a user, to place a telephone call, by:
identifying the telephone number for the first party on said sorted list; and
dialing said identified telephone number.

2. The method of claim 1 wherein said step of sorting is performed periodically.

3. The method of claim 1 wherein said step of sorting is performed in response to the receipt of a new event.

4. The method of claim 1 wherein said step of sorting comprises the step of:
sorting the ordering of entries in said list of telephone calls to be made by their time of entry, listing older entries before newer entries.

5. The method of claim 1 further comprising the steps of:
determining when callees corresponding to entries in said calling list are available to accept a call;
determining the current time and date; and
sorting said list of telephone calls to be made, placing entries for parties who are available at the current time and date, at a higher priority level, and placing entries for parties who are not available at the current time and date, at a lower priority level.

6. The method of claim 1 further comprising the steps of:
determining when callees corresponding to entries in said calling list are available to accept a call; and
displaying times and dates during which each callee is available.

7. The method of claim 1 further comprising the steps of:
responding to an email arriving at an associated address by automatically:
identifying the party sending said email; and
adding said identified emailing party to said call list.

8. The method of claim 1 further comprising the steps of:
responding to a voicemail arriving at an associated address by automatically:
identifying the party leaving said voicemail; and
adding said identified voicemailing party to said call list.

9. The method of claim 1 further comprising the step of:
responding to a user double-clicking on a contact in an address book by adding the name and telephone number associated with said contact, to said list of telephone calls to be made.

10. The method of claim 1 further comprising the step of:
responding to a user clicking on a request to manually enter a new call on said list of telephone calls to be made by:
providing said user with a data entry window including fields for a textual identifier and a telephone number for said new entry;
copying data entered into said fields, into a new data record for said new entry; and
refreshing said list of telephone calls to be made.

11. The method of claim 1 further comprising the steps of responding to a request from said user to add a new call with multiple parties by:
adding said new multi-party call to said list, including a textual identifier and a telephone number for each callee in said new call with multiple parties;
determining availability of each of said callees in said new call with multiple parties;
identifying on said list, the times and dates during which of said callees in said new multi-party call are available;
determining the current time and date; and
responding to said current time and date being a time when all of said parties in said new multi-party call are available, by raising the priority level of said new multi-party call in said call list.

12. The method of claim 1 further comprising the step of responding to a user request to manipulate the priority or order of said calls in said call list by adjusting the priority level accordingly.

13. The method of claim 1 further comprising the step of responding to a user request to delete an entry from said list of telephone calls to be made by:
deleting said entry; and
refreshing said list of telephone calls to be made.

14. The method of claim 1 wherein said step of calling said party comprises the prior steps of identifying the communication device on which a called party is most likely to be found and identifying the telephone number corresponding to said communication device.

15. The method of claim 1, further comprising the step of:
determining the willingness of a callee to accept a call, by sending a request to said callee's respective willingness engine, said willingness engine:
determining the callee's current context;
generating a response by considering said current context in view of pre-defined rules; and
transmitting a willingness response.

16. The method of claim 15 wherein said step of determining the callee's current context comprises the step of considering at least one callee criterion selected from the group consisting of:
day and time;
on/off hook of communication devices;
current activity;
PC activity;
communication history with the caller;
velocity of callee;
mood of callee;
ambient noise and environment; and
location of callee.

17. The method of claim 1 further comprising the step of allowing said user to specify when a telephone call should be made, and recording said specified time with said entry.

18. The method of claim 17 wherein said specified time is selected from the group consisting of:
call today;
call tomorrow;
call next week; and
call at a custom time and date.

19. The method of claim 1 further comprising the steps of:
determining whether a callee corresponding to an entry in said calling list is available to accept a call; and
responding to said callee being available by advising said user accordingly.

20. The method of claim 1 further comprising the step of responding to callee being unavailable, by making suggestions to said user of other ways of communicating with said callee.

21. The method of claim 20 wherein said other suggested ways of communicating may be selected from the group consisting of:
telephoning said callee during a specific time window or on a certain day;
sending an instant message to said callee during a specific time window or on a certain day; and
sending an email to said callee during a specific time window or on a certain day.

22. A method of operation for a telephony device comprising the steps of:
generating an electronic list of telephone calls to be made, each entry in said list including a textual identifier and a telephone number;
sorting the ordering of entries in said list of telephone calls to be made, by priority level, higher priority entries being placed higher on the list than lower priority entries;
displaying said sorted list on said telephony device; and
responding to a request by a user, to place a telephone call by:
identifying the telephone number for the first party on said sorted list;
placing said telephony device off-hook; and
dialing said identified telephone number on said telephony device.

23. The method of claim 22 wherein said telephony device is selected from the group consisting of:
a cellular telephone;
a desktop telephone;
a personal digital assistant;
a personal computer-based telephone;
an Internet-ready telephone;
a Voice over IP telephone; and
a television set-top box.

24. A telephony device comprising:
a memory for storing data and executable software code;
a processor for executing said stored software code;
a display operably connected to said processor;
a network interface for connecting said telephony device with one or more communication networks;
an audio input and output for communicating with a user;
said memory storing executable software code, operable to execute on said processors and perform the steps of:
generating an electronic list of telephone calls to be made, each entry in said list including a textual identifier and a telephone number;
sorting the ordering of entries in said list of telephone calls to be made, by priority level, higher priority entries being placed higher on the list than lower priority entries;
displaying said sorted list on said display; and
responding to a request by a user, to place a telephone call by:
identifying the telephone number for the first party on said sorted list; and
dialing said identified telephone number.
